(19) United States
(12) Patent Application Publication
(10) Pub. No.: US 2014/0178554 A1
(43) Pub. Date: Jun. 26, 2014

(54) PROCESS FOR THE PREPARATION OF A FROZEN DAIRY-BASED PRODUCT

(71) Applicant: Jonas Bohn, Svaneke (DK)

(72) Inventor: Jonas Bohn, Svaneke (DK)

(73) Assignee: SVANEKE IS APS, Svaneke (DK)

(21) Appl. No.: 14/129,318

(22) PCT Filed: Jun. 29, 2012
(86) PCT No.: PCT/EP2012/062732

§ 371 Date: Feb. 5, 2014

(30) Foreign Application Priority Data
Jun. 30, 2011 (EP) PCT/EP2011/061084
Jul. 15, 2011 (EP) 11174133.6

(51) Int. Cl. A23G 9/32; A23G 9/08

(52) U.S. Cl. CPC A23G 9/32; A23G 9/08
USPC 426/565; 426/519

(57) ABSTRACT

A process for the preparation of a frozen dairy-based product such as ice-cream is described. In at least one embodiment, the product requires no addition of artificial emulsifiers, stabilisers or milk powder and exhibits an excellent mouthfeel, no sandiness and/or a long shelf-life.

### FIELD OF THE INVENTION

The present invention relates to a process for the preparation of a frozen dairy-based product from naturally-occurring ingredients.

### BACKGROUND OF THE INVENTION

The quality of frozen dairy-based products such as ice cream is typically determined by the flavour, body and texture, where body represents the overall quality (e.g., mouthfeel) and the texture reflects the quality of specific parameters (e.g., sandiness) (Marshall et al., 2003). For the food industry, it is also important that the quality of a product is retained over time. Particularly for frozen dairy-based products, the growth of ice crystals limits the shelf-life of the product.

Traditionally, frozen dairy-based products such as ice cream products contain stabilisers and emulsifiers in order to provide a desired quality product. Stabilisers are typically added in order to provide softness and uniformity, secure a longer time for thawing and reduce formation of ice crystals, while emulsifiers are added in order to provide uniformity, scoopability and provide a more simple process. Furthermore milk powder is frequently used in order to increase the solids content and thereby improve the mouthfeel and reduce sandiness. However, in today's health conscious environment it would be desirable to be able to provide a frozen dairy-based product which is based solely on naturally occurring ingredients, is free from any artificial ingredients and which nonetheless provides an excellent high quality product.

WO 98/09534 A discloses a frozen aerated product having no added emulsifier and preferably no added stabiliser and having a fat content of from 6 to 18% as well as a process for the preparation thereof.

EP 1913819 A1 discloses a frozen aerated confection and methods for production thereof, wherein said confection comprises water, a fat component in an amount of 1 to 15% by weight, wherein greater than 20% and less than 35% by weight of the fatty acids in the fat component are polyunsaturated, and less than 65% by weight of the fatty acids are saturated, mammalian milk protein, and sweetener, and wherein the frozen confection contains less than 0.04% emulsifier by weight of the frozen confection.

JP 2001275575 A discloses a method for producing ice cream, said process comprising preparing an ice cream mix by mainly including nonfat milk solids, milk fat, a sweetener, and an egg ingredient without formulating a stabiliser and emulsifier, to adjust the milk fat proportion to 10-18% by weight, homogenising the resultant ice cream mix with a homogenizer under a homogenising pressure of ≧300 gkf/cm2, and freezing the resultant mix at a freezing temperature of ≦−3° C. but >−5° C.

WO 02/080693 A1 describes a process for the preparation of a frozen dairy-based product comprising a sweetener composition comprising sucrose and maltose.

There is a need for a process for preparing a frozen dairy-based product, such as an ice cream product, which is based solely on naturally occurring ingredients.

### SUMMARY OF THE INVENTION

It is an object of the invention to provide a process for the preparation of a frozen dairy-based product exhibiting a high-quality body and texture and/or a long-shelf-life without the addition of artificial emulsifiers, artificial stabilisers or milk powder. It is further an object of the invention to provide such a process for the production of a frozen dairy-based product, such as ice cream, wherein the product exhibits an excellent mouthfeel and no sandiness. It is further an object of the invention to provide such a process for the production of a frozen dairy-based product, such as ice cream, wherein the product exhibits a long shelf-life, optionally a longer shelf-life than a product prepared by a different process using the same or similar ingredients and/or a product prepared using artificial stabilizers but the same or similar process steps. In particular, the process is suitable for the preparation of an ice-cream product.

So, in a first aspect the present invention relates to a process for the preparation of a frozen dairy-based product, such as an ice cream product, wherein said product does not contain any artificial emulsifiers, stabilisers or milk powder, comprising the steps:
(a) homogenising a premix comprising milk and/or cream, egg ingredients, salt and one or more natural sweeteners at a suitable temperature and pressure;
(b) cooling the mixture obtained;
(c) optionally adding any natural flavours and/or fruit/vegetable compositions
(d) freezing the resulting mixture at a temperature below 0° C. (optionally with shear) in an ice cream making device defining an inlet and an outlet, by:
   i. feeding the resulting mixture into the inlet,
   ii. mixing the resulting mixture inside the ice cream making device, and
   iii. outputting the resulting ice cream product through the outlet; and
(e) subjecting the product of step (d) to deep freezing.

In another aspect, the present invention provides a premix for use in preparing an ice cream product by a continuous process, said pre-mix comprising or consisting of milk and/or cream, egg ingredients, salt and one or more natural sweeteners.

In yet another aspect, the present invention relates to a frozen dairy-based product, such as an ice cream product, obtainable by such a process, wherein said product contains no artificial emulsifiers, stabilisers or milk powder.

In a particular aspect, the above process is for the preparation of an ice cream product.

In a further aspect, the present invention relates to the use of an ice cream making device for performing the abovementioned method.

These and other aspects of the invention will be described in more details in the following sections.

### DETAILED DISCLOSURE OF THE INVENTION

The present invention relates to a process for the preparation of a an ice cream product exhibiting a high-quality body and texture and/or a long-shelf-life, using only emulsifiers that are present in the natural raw materials, such as, e.g., the casein content of milk, cream and eggs. After a series of tests, it was discovered that by careful selection of the process parameters, it was possible to achieve such a high-quality ice cream based on natural ingredients alone showing no sandiness, fat agglomeration or weak structure as experienced in prior art ice cream products.

### DEFINITIONS

Unless otherwise defined herein, all technical or scientific terms used herein have the same meaning as commonly understood by one of ordinary skill in the art (e.g., in frozen dairy-based product manufacture). The term “frozen-dairy based product” as used herein refers to a sweet-tasting fabricated foodstuff intended for consumption in the frozen state, and specifically includes ice cream products.

Unless otherwise stated (e.g., in relation to overrun), percentages described herein refer to percentage by weight of the total composition.

The milk and/or cream ingredients used in the process of the invention include cow's milk and cream such as whole milk, skim-milk, half-and-half and the like, but does not include condensed milk or skim milk, whey, or milk proteins in dry or solid form such as casein, non-fat dry milk and milk-powder. Typically, a milk ingredient has a fat content of 0.1% by weight up to 5% by weight, such as 3.5-4% by weight, and a cream ingredient a fat content of 30% by weight up to 40% by weight, such as 36-38% by weight. Any combination of milk and cream may also be used.

The term “sugar” as used herein includes any naturally-occurring monosaccharide such sucrose (saccharose), dextrose, fructose and any combination thereof.

The “shelf-life” as used herein refers primarily to the length of time a frozen dairy-based product can be stored without major crystallization and/or iciness. For example, in comparing two ice cream preparations for shelf-life, the ice cream having the lowest amount of ice crystals and/or the lowest growth rate of ice crystals after a pre-determined time of storage under the same conditions has the longer shelf-life. Exemplary and non-limiting storage times include 1 week, 2 weeks, 3 weeks, 1 month, 2 months, 3 months, 4 months, 6 months, 8 months, 12 months, 18 months and 24 months.

Definitions and descriptions of various terms and general techniques used in frozen dairy-based product manufacture can be found in “Ice Cream” (Marshall et al., 2003).

### Specific Aspects and Embodiments of the Invention

In one aspect, the present invention provides a process for the preparation of a frozen dairy-based product, such as an ice cream product, wherein said product does not contain any artificial emulsifiers, stabilisers or milk powder, comprising steps (a) to (e) described above under Summary of the Invention.

In one embodiment, the temperature in step (a) is in the range of about 70° C. to about 90° C., preferably in the range 75° C. to about 85° C., such as in the range of about 75° C. to 80° C., for example about 75° C. or about 80° C.

In an additional or alternative embodiment, the pressure in step (a) is in the range of about 120-180 bar, preferably about 125-175 bar, such as about 130-150 bar, for example about 130 bar or about 150 bar.

In an additional or alternative embodiment, the premix in step (a) is prepared by combining milk and/or cream, and egg ingredients, which are heated to a temperature in the range of about 30° C. to about 70° C., such as in the range of about 40° C. to about 60° C., for example about 50° C., whereupon one or more natural sweeteners are added.

The premix may comprise milk, cream or a mixture of milk and cream. In one embodiment, the premix comprises about 40-60% by weight, such as about 50% by weight, of milk with a fat content of about 3.5%.

The egg ingredients may comprise egg yolks, egg whites, or both egg yolks and egg whites. In one embodiment, the egg ingredients consist of egg yolks. In one embodiment, the egg ingredients consist of egg whites. In one embodiment, the egg ingredients consist of egg yolks. In one embodiment, the egg ingredients comprise egg yolks and egg whites added together. In one embodiment, the egg ingredients comprise separately added egg yolks and egg whites. In one embodiment, the egg ingredients consist of separately added egg yolks and egg whites.

Salt may be included in the premix and is typically included in the premix in an amount below about 0.05% by weight, such as from 0.01 to 0.05% by weight, such as about 0.03% by weight.

The one or more natural sweeteners may comprise a sugar, caramelized sugar, honey, syrup, or any mixture thereof. In one embodiment, the natural sweetener is sucrose. In one embodiment, the natural sweetener is honey. In one embodiment, the natural sweetener is a mixture of sucrose and honey, such as about 10-20% by weight of sucrose and about 1-2% by weight of honey in the premix, such as about 15% by weight of sucrose and about 1.5% by weight of honey. In one embodiment, the natural sweetener is not maltose. In one embodiment, the natural sweetener is not provided in the form of corn-syrup, such as High-Maltose Corn Syrup (HMCS).

In an additional or alternative embodiment, the mixture is cooled in step (b) to a temperature below about 15° C., preferably to a temperature in the range of about 2-10° C., such as a temperature in the range of about 4-7° C., for example about 5° C. In one embodiment, the mixture is cooled for a period of time in the range of 4-30 hours, such as about 6-24 hours, such as about 12-24 hours, such as about 18-24 hours.

In one embodiment, no natural flavour or fruit/vegetable composition is added in step (c). In one embodiment, a natural flavour is added in step (c), which natural flavour is selected from the group consisting of vanilla, cinnamon, ginger, star anis, chili, mint, chocolate, cocoa, herbs such as rosemary, malt, nuts, almonds, honey, syrup, and any combination thereof. In one embodiment, a fruit/vegetable composition is added in step (c), selected from the group consisting of a fruit paste and a fruit syrup, or a combination thereof, such as blueberry or strawberry-rhubarb. In one embodiment, a combination of one or more preceding natural flavours and one or more fruit/vegetable compositions is added to the mixture in step (c), such as apple-cinnamon. In one embodiment, the fruit/vegetable composition is added to the mixture at about 10% to about 40%, such as at about 20 to about 30%, such as at about 25%, by weight.

Steps (a) and (b) may take place in a first vessel, optional step (c) in the first or a second vessel, after which the mixture is transferred to vessel for a dynamic freezing process, which typically takes place in an ice cream freezer, for freezing and aerating the frozen mix. In the context of the present invention the vessel for a dynamic freezing process is also called an ice cream making device.

Accordingly, in an additional or alternative embodiment, step (d) comprises freezing the resulting mixture at a temperature lower than 0° C., preferably a temperature of about −3° C. to about −10° C., a temperature in the range of about −4° C. to about −8° C., such as about −5° C. to about −6° C., (optionally with shear). In one embodiment, in step (d), the mixture is frozen for a period of time of at least 2 hours, preferably in the range of about 4-24 hours, (optionally with shear).

In an additional or alternative embodiment, the freezing in step (d) may be performed in a screw extruder at a screw rotation rate higher than 360 rpm, such as from about 400 to about 700 rpm, such as at least 400 rpm, such as about 550 to about 600 rpm, such as from about 570 to about 580 rpm, such as about 575 rpm, such as 576 rpm. In one embodiment, the rotational velocity in step (d) is at least about 550 rpm, such as from about 570 to about 580 rpm, to allow for a reduced residence time on the inner surface of the ice cream making device and the egg ingredients in step (a) are separately added egg yolks and egg whites, providing an improved, non-buttery and non-greasy mouthfeel. In one embodiment, the freezing in step (d) may be performed in a screw extruder at a screw rotation rate higher than 50 Hz, such as from about 60 to about 100 Hz, such as about 75 to about 85 Hz, such as about 80 Hz.

In an additional or alternative embodiment, the product of step (d) is in step (e) subjected to freezing at a temperature lower than about −11° C., preferably in the range of −11° C. to about −40° C., such as at a temperature in the range of about −12° C. to about −35° C., such as about −15° C. to about −30° C., such as about −18° C. to about −25° C. In an alternative embodiment, step (e) comprises “blast freezing”, typically at a temperature from about −30° C. to about −45° C., with a high windchill effect.

In one aspect, the present invention provides a process for the preparation of a frozen dairy-based product, such as an ice cream product, wherein said product does not contain any artificial emulsifiers, stabilisers or milk powder, comprising the steps:
(a) homogenising a premix comprising milk and/or cream, egg ingredients, one or more natural sweeteners and optionally salt at a temperature in the range of about 75° C. to about 85° C. and a pressure in the range of about 125-175 bar;
(b) cooling the mixture obtained to a temperature in the range 2-10° C.;
(c) optionally adding any natural flavours and/or fruit/vegetable compositions;
(d) freezing the resulting mixture at a temperature of about −3° C. to about −10° C. (optionally with shear) in an ice cream making device defining an inlet and an outlet, by:
   i. feeding the resulting mixture into the inlet,
   ii. mixing the resulting mixture inside the ice cream making device, and
   iii. outputting the resulting ice cream through the outlet;
      optionally by performing the step in a screw-extruder at a screw rotation rate at 400 to 700 rpm; and
(e) subjecting the product of step d) to freezing at a temperature in the range of −11° C. to about −40° C.

In one embodiment, the egg ingredients comprise separately added egg yolks and egg whites.

In one embodiment, the premix in step (a) is prepared by combining milk and/or cream, such as milk (3.5% fat content), and egg ingredients, such as separately added egg yolks and egg whites, and the combination heated to a temperature in the range of about 40° C. to about 60° C., such as about 40° C., whereupon one or more natural sweeteners are added. In one embodiment, the mixture is then homogenised at about 75-80° C. and about 130-150 bar.

In one embodiment, in step (b) the mixture is cooled to a temperature in the range 4-7° C., such as about 5° C., for a period of time in the range of 4-30 hours, such as about 6-24 hours, such as about 12-24 hours, such as about 18-24 hours.

In one embodiment, in step d) the mixture is then cooled to a temperature in the range of about −4° C. to about −8° C. for a period of time in the range of about 4-24 hours.

In one embodiment, the freezing in step (d) is performed in an ice cream making device (see description below) which comprises a mixing device which is rotated inside the mixing device such as a screw extruder, at a rotation rate of about 550 to about 600 rpm, such as from about 570 to about 580 rpm, such as about 575 rpm, such as 576 rpm.

The ice cream making device defines an inlet and an outlet which are different from one another. Accordingly during use, the resulting mixture in through from the inlet, further through the ice cream making device and finally out through the outlet.

The cross-sectional shape of the ice cream making device (in a direction transverse to the longitudinal and/or flow direction of the ice cream making device) may be round, such as circular. In one embodiment, the ice cream making device has a diameter in the range of 50-5000 mm, such as in the range 100-1000 mm, such as 100 mm, such as 200 mm, such as 300 mm, such as 400 mm, such as 500 mm.

In one embodiment, the length of the ice cream making device may be at least 500 mm, such as at least 1000 mm, such as at least 5000 mm, such as in the range 500 mm to 5000 mm, such as in the range 1000 to 2000 mm.

The chamber defined by the ice cream making device may have a volume of at least 500 cm³, such as at least 5000 cm³, such as at 50,000 cm³, such as at 500,000 cm³, such as at 5,000,000 cm³, such as in the range 1000 cm³ to 100,000 cm³, such as in the range 10,000 to 50,000 cm³.

In one embodiment, the step “d) freezing the resulting mixture” comprises the step of feeding the resulting mixture out through the outlet at a velocity below 12 cm/s, such as below 10 cm/s, such as below 8 cm/s, such as below 6 cm/s, such as below 4 cm/s, such as in the range 2 to 10 cm/s, such as in the range 5-9 cm/s. These velocities may in one embodiment be achieved in that part of the ice cream making device, where one or more ice cream mixing devices are provided—see below.

In one embodiment, the step “d) freezing the resulting mixture” comprises the step of feeding the resulting mixture out through the outlet at a volume per time unit in the range of 100 liter/hour to 300 liter/hour, such as 160 liter/hour to 260 liter/hour, such as 160 liter/hour, such as 170 liter/hour, such as 180 liter/hour, such as 190 liter/hour, such as 200 liter/hour, such as 210 liter/hour, such as 220 liter/hour, such as 230 liter/hour, such as 240 liter/hour, such as 250 liter/hour, such as 260 liter/hour.

In one embodiment, the ice cream making device comprises one or more pumps which are adapted and operated to pump the resulting mixture from the inlet to the outlet. In one embodiment, the movement of the resulting mixture is only achieved by means of these pumps. In one embodiment, a upstream pump may be provided upstream the inlet. Alternatively, or as a supplement, a downstream pump may be provided downstream the outlet.

If the inlet and/or the outlet does/do not have the same cross-sectional area as the cross-sectional area of the ice cream making device (in a direction transverse to the flow direction), then it will be appreciated that the velocity in the inlet and/or the outlet will be different from the velocity inside the ice cream making device.

In one embodiment, the ice cream making device comprises a mixing device. In the latter embodiment, the step “ii) mixing the resulting mixture inside the ice cream making device” comprises the step of operating the mixing device so as to move the resulting mixture at a tangential velocity of at least 1500 mm/s along an inner surface of the ice cream mixing device, such as at least 1800 mm/s, such as at least 2000 mm/s, such as at least 2500 mm/s, such as at least 3000 mm/s, such as at least 3500 mm/s, such as in the range 1500 to 3500 mm/s, such as in the range 1800 to 3200 mm/s.

In one embodiment, the mixing device is adapted to move the resulting mixture in a direction which defines no component in the longitudinal direction i.e. the mixing device is only capable of moving the resulting mixture along the circumference of the inner surface. Alternatively, the mixing device may be adapted to move the resulting mixture in both the longitudinal direction and in the circumferential direction, whereby the mixing device causes the resulting mixture to be moved in a helical direction.

In order to move the resulting mixture along the circumference, the mixing device may comprise one or more mixing arms, such as one, such as two, such as three, such as four, such as five, such as six. The mixing arms may be extend from a shaft which is rotatable inside the ice cream making device. In one embodiment, the shaft is hollow. It will be appreciated that in some embodiments, the rotational axis of the shaft coincides with the center axis of the cylinder defined by the ice cream mixing device. Each of these mixing arms may define an end surface which when the shaft is rotated is caused to move along the inner surface of the ice cream making device. These arms may be adapted and arranged to move the resulting mixture along the inner surface as specifies above.

In one embodiment, the step of “ii) mixing the resulting mixture inside the ice cream making device” comprises the step of operating the mixing device such that the resulting mixture is scraped off the inner surface at least every tenth of a second ( 1/10 sec), such as at least every fifteenth of a second ( 1/15 sec), such as every eighteenth of a second ( 1/18 sec), such as every twentieth of a second ( 1/20 sec), such as every twenty-fifth of a second ( 1/25 sec), such as every thirtieth of a second ( 1/30 sec), such as every fortieth of a second ( 1/40 sec), such as between every fifteenth of a second ( 1/15 sec) and every fortieth of a second ( 1/40 sec), such as between every eighteenth of a second ( 1/18 sec) and every thirtieth of a second ( 1/30 sec). By “scraped off” shall be understood that the mixing arms causes the resulting mixture which is in direct contact with the inner surface of the ice cream making device to be moved away from this inner surface whereby other parts of the resulting mixture is allowed to flow into contact with the inner surface. The effect is that the resulting mixture is prevented from being in contact with the inner surface for an unwanted long period of time whereby formation of ice crystals may be prevented or reduced.

In one embodiment, the ice cream making device is adapted to add air to the resulting mixture so as to increase the volume of the ice cream (relative to the amount of resulting mixture added). In one embodiment the ice cream making device is adapted to air to the resulting mixture such that the air constitutes up to 80 percent of the volume of the ice cream, such as up to 60 percent, such as up to 40 percent, such as up to 20 percent, such as in the range 20-30 percent, such as 23 percent.

In one embodiment, the process provides an ice cream product comprising at least 3% by weight of fat (mainly butterfat), such as 10 to 20% by weight, such as 12 to 18% by weight, such as about 15% by weight of fat.

In another embodiment, the present invention provides a premix for use in preparing an ice cream product by a continuous process, said pre-mix comprising milk and/or cream, egg ingredients, salt and one or more natural sweeteners.

In one embodiment, the pre-mix comprises:
(a) 40-60% by weight, such as about 50% by weight, of milk with a fat content of about 3.5%;
(b) 2-10% by weight, such as 2-5% by weight, such as 3-4% by weight of egg ingredients;
(c) 0.0 to 0.05% by weight of salt; and
(d) 10 to 35% by weight, such as 10 to 25% by weight of natural sweetener.

In separate and specific embodiments, the egg ingredients consist of egg whites, egg yolks, or both egg whites and egg yolks.

In other separate and specific embodiments, the pre-mix consists of milk, egg ingredients, natural sweetener and optionally salt.

In one embodiment, the natural sweetener is a mixture of sucrose and honey, such as about 10-20% by weight of sucrose and about 1-2% by weight of honey in the premix, such as about 15% by weight of sucrose and about 1.5% by weight of honey.

In one embodiment, the premix consists of said ingredients (a) to (d), optionally wherein the natural sweetener is a mixture of sucrose and honey.

In another embodiment, the invention provides a process, optionally continuous, for the preparation of an ice cream product, comprising the steps:
(a) homogenising the premix of the invention at a temperature in the range of about 75° C. to about 85° C. and a pressure in the range of about 125-175 bar;
(b) cooling the mixture obtained to a temperature in the range 2-10° C.;
(c) optionally adding any natural flavours and/or fruit/vegetable compositions;
(d) freezing the resulting mixture at a temperature of about −3° C. to about −10° C. (optionally with shear) in an ice cream making device defining an inlet and an outlet, by:
   i. feeding the resulting mixture into the inlet,
   ii. mixing the resulting mixture inside the ice cream making device, and
   iii. outputting the resulting ice cream product through the outlet; and
(e) subjecting the product of step d) to freezing at a temperature in the range of −11° C. to about −40° C.

In another aspect, the present invention provides for a frozen dairy-based product, such as an ice cream product, wherein said product contains no artificial emulsifiers, stabilisers or milk powder and is obtainable by the process according to any of the preceding aspects and/or embodiments or any combination thereof.

In yet another aspect, the present invention relates to the use of an ice cream making device for performing the method according to the first aspect of the invention.

### EXAMPLE 1

The following describes production of ice cream with vanilla, apple-cinnamon, blueberry, or strawberry-rhubarb flavour.

A pre-mix of all ingredients except for the flavouring was homogenized at a temperature of 60° C. and a pressure of 100 bar, and pasteurized. After cooling, flavouring was added, and the mixture subjected to cooling in a GIF 600 ice cream freezer (Gram Equipment A/S, Denmark) with a cylinder pressure of 3 bar and the following parameters:

| | | Apple- | | Strawberry- |
|---|---|---|---|---|
| Parameter | Vanilla | cinnamon | Blueberry | rhubarb |
| Relative dasher speed¹ | 100 | 100 | 160 | 160 |
| Liters of mix/hour | 100 | 100 | 160 | 160 |
| Liters of ice cream/hour | 160 | 160 | 260 | 260 |
| Overrun (%) | 60 | 60 | 63 | 63 |
| Viscosity | 40 | 40 | 80 | 80 |
| Exit temperature (° C.) | −5.2 | −5.9 | −5.2 | −5.2 |

¹100 = 50 Hz = 360 rpm; 160 = 80 Hz = 576 rpm.
“Overrun” is the percentage of difference in volume between ice cream mix and resulting ice cream, reflecting how much air has been incorporated into the ice cream.
“Viscosity”, which is reverse proportional to the exit temperature, is here presented in relative terms reflecting the amount of power needed for the shear step.

### EXAMPLE 2

Ice cream based on any of the above flavourings is produced as described in Example 1, except for homogenising the pre-mix at 75-80° C. and 130-150 bar, and using a relative dasher speed of 160.

The relative amounts of ice cream mix and fruit are 75% and 25%, respectively.

### EXAMPLE 3

An ice cream mix was prepared from the following ice cream formulation:

| Ingredient | Weight (kg) | Weight percentage |
|---|---|---|
| Milk (3.5%) | 506.7401 | 50.67 |
| Cream (38%) | 245.9904 | 24.60 |
| Sucrose | 147.5942 | 14.76 |
| Egg yolks (pasteurized) | 54.1179 | 5.41 |
| Egg whites (pasteurized) | 29.5188 | 2.95 |
| Honey | 15.7434 | 1.57 |
| Salt | 0.2952 | 0.03 |

All pre-mix of all ingredients was homogenized at a temperature of 75° C. and a pressure of 130 bar, and pasteurized at 85° C.

The mixture was then frozen to a temperature of −5.5° C. at a shear rate of 60% above STANDARD (where STANDARD is 50 Hz corresponding to 360 rpm), i.e., 576 rpm.

### LIST OF REFERENCES

www.foodsci.uoguelph.ca/dairyedu/icmanu.html
Marshall, Robert T., et al., “Ice Cream”, 6^{th} Ed., 2003 (Kluwer Academic/Plenum Publishers).

1. A process for the preparation of an ice cream product, wherein the product does not contain any artificial emulsifiers, stabilisers or milk powder, comprising:
(a) homogenising a premix comprising at least one of milk and cream, egg ingredients, one or more natural sweeteners and optionally salt and at a temperature in the range of about 75° C. to about 85° C. and a pressure in the range of about 125-175 bar to provide a mixture;
(b) cooling the mixture obtained to a temperature in the range 2-10° C.;
(c) optionally adding any of at least one of natural flavours and fruit/vegetable compositions;
(d) freezing the resulting mixture at a temperature of about −3° C. to about −10° C. in an ice cream making device defining an inlet and an outlet, by:
i. feeding the resulting mixture into the inlet,
ii. mixing the resulting mixture inside the ice cream making device, and
iii. outputting the resulting ice cream product through the outlet; and
(e) subjecting the resulting ice cream product of d) to freezing at a temperature in the range of −11° C. to about −40° C.

2. The process of claim 1, wherein in d) freezing the resulting mixture comprises feeding the resulting mixture from the inlet to the outlet at a velocity below 12 cm/s.

3. The process of claim 1, wherein the ice cream making device comprises a mixing device and wherein in d), ii) mixing the resulting mixture inside the ice cream making device comprises operating the mixing device so as to move the resulting mixture at a velocity of at least 1500 mm/s along an inner surface of the ice cream mixing device.

4. The process of claim 1, wherein the ice cream making device comprises a mixing device and wherein in d), ii) mixing the resulting mixture inside the ice cream making device comprises operating the mixing device such that the resulting mixture is scraped off an inner surface of the ice cream mixing device at least every tenth of a second.

5. The process of claim 1, wherein the egg ingredients comprise egg yolks, egg whites, or both.

6. The process of claim 1, wherein the egg ingredients comprise separately added egg yolks and egg whites.

7. The process of claim 1, wherein salt is included in the premix in an amount below about 0.05% by weight.

8. The process of claim 1, wherein the one or more natural sweeteners comprise a sugar, honey, syrup, or any mixture thereof.

9. The process of claim 1, wherein the premix in a) is prepared by combining at least one of milk and cream, and egg ingredients, which are heated to a temperature in the range of about 40° C. to about 60° C., whereupon one or more natural sweeteners are added.

10. The process of claim 1, wherein the natural flavours are selected from the group consisting of vanilla, cinnamon, ginger, star anis, chili, mint, chocolate, cocoa, herbs, malt, nuts, almonds, caramelized sugar, honey, syrup, and any combination thereof.

11. The process of claim 1, wherein the fruit/vegetable compositions are selected from the group consisting of fruit pastes and fruit syrups.

12. The process of claim 1, wherein in b) the mixture is cooled to a temperature in the range 4-7° C. for a period of time in the range of 4-30 hours.

13. The process of claim 1, wherein in d) the mixture is cooled to a temperature in the range of about −4° C. to about −8° C. for a period of time in the range of about 4-24 hours.

14. The process of claim 1, wherein d) is performed in a screw extruder and the screw rotation rate in d) is from about 400 to about 700 rpm.

15. (canceled)

16. The process of claim 1, wherein the freezing in e) is performed at a temperature in the range of about −12° C. to about −35° C.

17. The process of claim 1, wherein the process is a continuous process.

18. A pre-mix for use in preparing an ice cream product by a continuous process, said pre-mix comprising:
40-60% by weight milk with a fat content of about 3.5%;
2-10% by weight of egg ingredients;
0.0 to 0.05% by weight of salt; and
10 to 35% by weight of natural sweetener.

19. The pre-mix of claim 18, wherein the pre-mix consists of milk, egg ingredients, natural sweetener, and salt.

20. A continuous process for the preparation of an ice cream product, comprising:
(a) homogenising the premix of claim 18 at a temperature in the range of about 75° C. to about 85° C. and a pressure in the range of about 125-175 bar to provide a mixture;
(b) cooling the mixture obtained to a temperature in the range 2-10° C.;
(c) optionally adding any of at least one of natural flavours and fruit/vegetable compositions;
(d) freezing the resulting mixture at a temperature of about −3° C. to about −10° C. in an ice cream making device defining an inlet and an outlet, by:
i. feeding the resulting mixture into the inlet,
ii. mixing the resulting mixture inside the ice cream making device, and
iii. outputting the resulting ice cream product through the outlet; optionally by performing the step in a screw-extruder at a screw rotation rate at 400 to 700 rpm; and
(e) subjecting the resulting ice cream product of d) to freezing at a temperature in the range of −11° C. to about −40° C.

21. An ice-cream product, wherein said ice cream product contains no artificial emulsifiers, stabilisers or milk powder, obtainable by the process of claim 1.

22. (canceled)

23. An ice-cream product, wherein said ice cream product contains no artificial emulsifiers, stabilisers or milk powder, obtainable by the process of claim 20.

24. The pre-mix of claim 18, wherein the pre-mix comprises:
50% by weight of milk with a fat content of about 3.5%;
2-5% by weight of egg ingredients;
0.0 to 0.05% by weight of salt; and
10 to 25% by weight of natural sweetener.

25. The pre-mix of claim 18, wherein the pre-mix comprises:
3-4% by weight of egg ingredients.

26. The pre-mix of claim 18, wherein the pre-mix consists of milk, egg ingredients, natural sweetener, salt and cream.
